(19) United States
(12) Patent Application Publication
(10) Pub. No.: US 2003/0039601 A1
(43) Pub. Date: Feb. 27, 2003

(54) Oxygen ion transport membrane apparatus and process for use in syngas production

(76) Inventors: Thomas Gilbert Halvorson, Lockport, NY (US); Victor Emmanuel Bergsten, East Amherst, NY (US); Prasad S. Apte, East Amherst, NY (US); Nitin Ramesh Keskar, Lewisville, TX (US); Christo Steyn, Sasolburg (ZA); Richard Andrew Vanslooten, East Aurora, NY (US)

Correspondence Address: PRAXAIR, INC., LAW DEPARTMENT - M1 557, 39 OLD RIDGEBURY ROAD, DANBURY, CT, 06810-5113, US

(21) Appl. No.: 09/925,366

(22) Filed: Aug. 10, 2001

(51) Int. Cl. C01B 3/26; B01L 7/00; B01J 8/00

(52) U.S. Cl. 422/198; 423/651; 422/211; 422/228; 422/197; 422/200; 422/201; 422/205

(57) ABSTRACT

A reaction vessel for the production of synthesis gas that contains four subassemblies: (1) a first heat exchanger that transfers heat between two low pressure streams (an oxygen containing stream and an oxygen depleted stream); (2) a second heat exchanger that transfers heat between two high pressure fluid streams (a hydrocarbon-containing reactant stream and a synthesis gas product stream); (3) mixed conductor ceramic membranes; and (4) a catalyst bed. Each of these subassemblies are configured so that they freely expand or contract independently from each other, and to thus avoid inducing high mechanical loads and damaging material stresses.

### FIELD OF THE INVENTION

The present invention relates to an oxygen ion transport membrane apparatus and process for use in both synthesis gas and hydrogen production. More particular the present invention relates to such an apparatus and process in which a synthesis gas product stream is produced from oxygen and hydrocarbon-steam containing feed streams within a reaction vessel having integrated heat exchangers and a reaction section that are all independently supported within the reaction vessel.

### BACKGROUND OF THE INVENTION

The separation of oxygen from an oxygen-containing gaseous stream is a process step in a number of commercially significant manufacturing operations. One method of oxygen separation utilizes ion and electron conducting ceramic membrane materials (also sometimes referred to as an “oxygen ion transport membrane” or “OTM” or an “ionic/mixed conductor membrane unit”). Oxygen ions and electrons are selectively transported through this non-porous ceramic membrane material that is impervious to other species.

Suitable ceramic membrane materials include mixed conducting, that is ion and electron conducting, metal oxides and dual phase combinations of ion conducting metal oxides and electron conducting metals and metal oxides. Exemplary ceramic compositions are disclosed in U.S. Pat. Nos. 5,342,431; 5,599,383; 5,648,304; 5,702,999; 5,712,220; 5,733,435; 6,214,757; and Japanese Patent Application (Kokai) No. 61-21717. Ceramic membranes formed from an ion and electron conducting metal oxides typically exhibit the property of oxygen selectivity. “Oxygen selectivity” means that only oxygen ions are transported across the membrane with the exclusion of other elements and ions. Particular advantageous solid electrolyte ceramic membranes are made from inorganic oxides, typically containing calcium- or yttrium-stabilized zirconium or analogous oxides having a fluorite, brownmillerite or perovskite structure. Use of such membranes in gas purification applications is described in U.S. Pat. No. 5,733,069.

Ceramic membrane materials have the ability to transport oxygen ions and electrons at the prevailing oxygen partial pressure in a temperature range of from about 450° C. to about 120° C. when a chemical potential difference is maintained across the membrane element. This chemical potential difference is established by maintaining a positive ratio of oxygen partial pressures or an electrical gradient across the ion transport membrane. The oxygen partial pressure (P₀₂) or electrical gradient is maintained at a higher value on the cathode side of the membrane, that side exposed to the oxygen-containing gas, then on the anode side, where the transported oxygen is recovered or used. With a gradient in chemical potential (oxygen partial pressure or electrical potential) oxygen ions can be transported against a gradient in total pressure, that is from a lower total pressure at the cathode to a higher total higher pressure at the anode.

In the past, oxygen ion transport membrane (OTM) designs have experienced survivability and gas leakage problems. For example, membrane designs in the shape of open-both-end (OBE) reactor tubes could not survive multiple heating and cool down cycles without fracturing. Sealing both ends of such ceramic membrane tubes that tend to grow or shrink significantly from thermal and compositional expansion require at least one sliding radial seal. Minimizing gas leakage across this seal under high pressure differentials is problematic.

It would be useful to integrate OTM designs into high temperature, high pressure gas-to-gas heat exchangers to achieve efficient thermal energy recovery. However, it has been very difficult to do this. Practical designs for these gas-to-gas heat exchangers have been severely constrained by the properties of the metallic alloys used in OTM designs. For example, minimal strength remains in heat exchanger material at the high reactor operating temperatures required for syngas oxidation reactions (800° C. to 1000° C.). Further, the creep-rupture properties of these materials must be factored in any heat exchanger design to reflect the high pressure containment stresses. Additionally, the heat exchanger design should take into account pressure levels and resulting pressure differences between adjacent gas streams so as to minimize material stresses. Integrated gas-to-gas heat exchangers operating at elevated temperatures may develop significant differences in tube wall temperatures when traditional shell-and-tube design concepts are employed. Non-uniform temperature distributions may result from variations in shell-side gas flow patterns and velocities.

Reactors producing synthesis gas (mixtures of hydrogen and carbon monoxide) (also called syngas) are known in the prior art. It is to be noted that the syngas is typically used in either a Fischer-Tropsch process for conversion to liquid products, or a process for conversion to methanol or a process for conversion to dimethyl ether. Reactors that use oxygen transport membrane technology generally require a design configuration such that the process feed gas (hydrocarbon-steam mixture) enters the reactor at elevated pressure while the air stream (oxidant stream) is provided at a pressure slightly above normal atmospheric levels. This design requirement demands that a substantial pressure difference be maintained across the sealing element for the membrane tubes. This sealing element will isolate the high pressure fuel stream from the low pressure oxidant stream. Should that sealing element fail abruptly or develop an unexpected leakage path during operation, high pressure fuel will immediately mix with an oxygen containing gas at high temperature to form intense jets of flame. These jets of flame may impinge on nearby reactor components and severely compromise their pressure-containing capability. A potentially dangerous safety incident could occur if the reactor cannot contain the high pressure, high temperature fuel. Accordingly, physical separation and isolation of the fuel and oxidant streams is essential to reduce the risk of fire and maintain the operating safety of the membrane reactor.

The prior art has attempted to solve the problems associated with differential thermal expansion through use of internal metallic expansion joints and floating tubesheets. These devices are needed when sealing both ends of hot reforming tubes inside of reactor vessels. U.S. Pat. No. 5,567,398 teaches a compact steam reformer that utilizes multiple metallic bellows to accommodate differential thermal expansion of internal components. U.S. Pat. No. 5,567,933 describes another reactor for steam reforming that specifically utilizes convective heat exchange between the product gas and the process feed gas. The heat exchanger tubesheet utilizes individual metallic bellows to accommodate differential thermal expansion. However, metallic bellows that can accommodate sufficient axial movement while operating at elevated temperatures often fail prematurely from fatigue and creep.

Synthesis gas contains a high percentage of carbon monoxide which is known to attack certain metal alloys in the temperature range of about 400° C. to about 700° C. in a phenomenon called metal dusting. This problem is especially acute in cooling synthesis gas which has a high carbon monoxide content. Metal dusting is a catastrophic carbonization of the alloy resulting in the formation of internal carbides that create pitting and thinning of metal structures in relatively short periods of time. Avoiding metal dusting requires either to keep metallic surfaces such as heat exchanger walls at temperatures outside the critical range, e.g. by having boiling water on one side of the wall, cooling a syngas product stream by quenching with water, thereby eliminating the need for heat exchangers in the critical temperature range, or by using a metal that resists metal dusting. One of the more resistant alloys to metal dusting is known to be HAYNES® 230 alloy, a nickel-chromium-tungsten molybdenum alloy. However, such special resistant alloys are expensive and greatly increase the cost of the reactor. If a protective atmosphere could be used to separate the syngas from contacting the OTM tubesheet, then less expensive alloys (e.g. INCOLOY® 800 HT alloy) could be used for the OTM tubesheet and overall cost of the reactor could be lessened.

Another process consideration is the avoidance of solid free carbon formation in the heat exchanger on the process feed side. Depending on gas composition, especially the presence of hydrocarbons heavier than methane, the critical temperature to be avoided in the heat exchangers is above 500 to 750° C. A possible way of raising the permissible temperature is employing a pre-reformer at an intermediate temperature. Prior art references addressing processes for the generation of syngas with ion transport membranes are: U.S. Pat. No. 5,865,878, which employs a syngas generating OTM membrane in an integrated gas turbine cycle and gives general guidance on the temperature ranges to be employed and uses either product quenching or waste heat boilers for cooling syngas product; U.S. Pat. No. 6,048,472, which mentions pre-reformers; and European Patent Application 0 882 670 A1 which offers general treatise of syngas generation with oxygen transport membranes including the aforementioned problems.

High temperature, high pressure gas-to-gas heat exchangers generally also have used internal insulation to keep vessel wall temperatures sufficiently low to satisfy material strength requirements. The overall physical size and weight of such insulated heat exchangers detracts from the ability to design compact, integrated reactor systems. Often it is not possible to operate all-metallic systems at temperature levels between about 800° C. and about 1100° C. required for preparation of syngas or oxidation thereof.

Alternatively, ceramic structures have been used for heat exchange surfaces. U.S. Pat. No. 5,775,414 presents a design for high temperature, high pressure air-to-air heat exchangers that rely on ceramic tubes, dome-style ceramic tubesheets, and external spring-loaded expansion devices. U.S. Pat. No. 5,599,383 describes a multi-tube mixed conductor ceramic membrane reactor. It uses open-both ended (OBE) tubes with gas manifolding on each end. These ceramic components bring additional sealing and manifolding problems.

Separately, the heat exchanger art has disclosed the use of catalyst beds in conjunction with heat exchanger tubes in a reaction vessel. U.S. Pat. No. 4,405,562 discloses a means for integrating an internal heat exchanger within a bed of catalyst. Flow through the catalyst bed takes place in two axial stages, each of which is in radial flow configuration. U.S. Pat. No. 5,190,731 discloses a means to equalize the temperature differences within a catalyst bed in order to accommodate exothermic reactions such as ammonia production. The bed consists of catalyst particles interspersed with cooling tubes. Gas flow within the bed is radially inward across the tubes toward a central conduit. However, neither of these references teaches the integration of the catalyst bed with an OTM system in the production of syngas.

Accordingly, a need exists for an OTM system for use in a reaction vessel for syngas production that does not use metallic expansion joints and can be configured in a manner that the internal subassemblies can freely expand or contract independently from each other, thereby avoiding the inducement of high mechanical loads and damaging material stresses. As will be discussed, the present invention provides a solution to this need and incorporates other advantageous inventive features.

### SUMMARY OF THE INVENTION

The present invention provides an apparatus for the production of synthesis gas that includes a reaction vessel. A first heat exchanger, located in one end of the reaction vessel is employed to heat a preheated oxygen containing stream by indirect heat exchange with an oxygen depleted stream. A second heat exchanger is located within the other end of the reaction vessel to heat a reactant stream comprising at least one hydrocarbon and steam by indirect heat exchange with a synthesis gas product stream. A plurality of oxygen transport membranes are located in a reaction section of the reaction vessel to separate oxygen from the oxygen containing stream, thereby to produce permeated oxygen at anode sides of the oxygen transport membranes. The oxygen transport membranes have cathode sides in communication with the first heat exchanger to receive the oxygen containing stream. The reaction section is in communication with the second heat exchanger so that the reactant stream is introduced to the anode side of oxygen transport membranes in the reaction section. A catalyst bed is located within the reaction section to promote the reaction of the permeated oxygen in a combination partial oxidation-reforming-water gas shift reaction to produce the synthesis gas product stream. First entrant and discharge passages in communication with the first heat exchanger and second entrant and discharge passages are in communication with the second exchanger to allow for passage of the oxygen containing and oxygen depleted streams and for passage of the reactant and synthesis gas product streams, respectively, to and from the reactor vessel. The first heat exchanger, the second heat exchanger, and the oxygen transport membranes each supported within the reactor vessel independently of one another so that each can independently expand or contract.

In such aspect of the present invention all of the internal metallic expansion joints with a membrane reactor can be eliminated by incorporating a nested or telescoping OTM and heat exchanger design that permits free relative displacements. For example, an OTM syngas reactor utilizing closed-end tubes can be configured in a manner such that the internal subassemblies can freely expand or contract independently from each other. This approach prevents the induction of high mechanical loads and damaging material stresses during operation.

In addition, the two internally-integrated heat exchangers can be included with the syngas/membrane reactor in a common pressure vessel shell. These can be fabricated using a low-cost mechanical design approach that is enabled by the relative positioning of the fluid streams. Using this design, one heat exchanger transfers heat between two high pressure fluid streams having minimal pressure difference (process feed gas and product syngas). The other heat exchanger transfers heat between two low pressure streams having minimal pressure difference (feed air and oxygen-depleted air). As these adjacent streams in both cases have little difference in operating pressure, the heat exchanger internal components will not be subjected to high stresses. Thin walled tubes and fabricated sheet material can be used to construct the heat exchangers.

Advantageously, the reactant section has baffle plates configured to produce a flow of the reactant gas through the reactant section and therefore the catalyst bed of one of: axial flow, cross-flow, combined axial and transverse flow; spiral flow; radially-segmented cross-flow; and transverse-segmented cross-flow. In cross-flow arrangement, the reactant section can have perforated shroud tubes surrounding oxygen transport membranes of tubular configuration. The use of a cross-flow arrangement is mandatory with such shroud tubes to avoid excessive axial bypassing of the catalyst bed by a major fraction of the process side flow through the annulus between the perforated shroud and mixed conducting membrane tubes. Additionally, the shroud tubes prevent contact between the membrane surface and the catalyst to enable independent removal and installation of membrane tubes and catalyst.

The oxygen transport membrane can be oxygen transport membrane tubes. An inert buffer gas zone can be provided between the reaction section and seal locations at the open ends of the oxygen transport membrane tubes to allow for introduction of a non-reactive gas therein at a pressure greater than that of the reactant zone to prevent leakage of reactant gas from the reactant stream into the oxygen containing stream.

Preferably, each of the first and second heat exchangers has a heat exchanger tubesheet connected to the reactor vessel and a plurality of tubes connected to said tubesheet for internal passage of said synthesis gas product stream and said oxygen containing stream, respectively. As will be discussed, each heat exchanger is a gas-to-gas heat exchanger and also includes thin-walled metal sheets formed into shell-side separator plates and flow passages. The ends of the heat exchangers opposite their tubesheets communicate with fluid streams from the reaction section that are of similar pressure levels: high pressure for the hydrocarbon-containing process streams (anode side) and low pressure for the oxygen-containing streams (cathode side). The tubes divide the first and second heat exchangers into oxygen containing feed and oxygen depleted gas sides and feed gas and product gas sides respectively, on opposite sides of said tubes. The second heat exchanger is configured such that higher mass velocities exist on said feed gas side than on said product gas side. This produces higher film coefficients on the feed gas side in such a fashion that tube wall temperatures can be maintained below levels where metal dusting occurs.

The oxygen transport membranes can be of tubular configuration and have opposed closed and open ends and are supported at their closed ends from a support tubesheet located between the heat exchanger tubesheets. As a result, the heat exchangers and oxygen transport membrane tubes are all independently supported by attachment of the tubesheets to the reaction vessel walls.

The second heat exchanger can have first and second stages with a catalytic pre-reforming section located between the stages. The pre-reforming section contains a pre-reforming catalyst to pre-reform hydrocarbons with more than one carbon molecules to form hydrogen and carbon monoxide therefrom. This helps to prevent the formation of free carbon at higher temperatures within the feed side of high temperature end of the second heat exchanger and at the entrance of the reforming section.

The reaction section can have a catalyst-free section at a location at which said reactant stream enters the reaction section to promote oxidation reactions over reforming reactions. This helps to promote rapid heating of reactant gases in the reactant stream and the oxygen transport membrane tubes. Further, the catalyst bed can also have an oxygen transport membrane-free section to define a catalytic equilibrating section. In such section, the reactant stream undergoes reforming reactions in the absence of oxygen permeate. This enhances the attainment of equilibrium between the process gas constituents leaving the reaction section.

Preferably, each of the oxygen transport ceramic membrane can be of tubular configuration and of composite construction with a porous support layer located on the anode side thereof and an adjacent dense membrane film located on the cathode side thereof. The reforming catalyst of said catalyst bed can be located at least in the outer portion of said porous support.

Optionally, the reaction vessel can be provided with an outer jacket to preheat the oxygen containing stream. A passageway communicates between the outer jacket and the first heat exchanger for flow of the oxygen containing stream thereto after having been preheated.

In another aspect, the present invention provides a process for the production of synthesis gas. In such process, an oxygen containing gas is compressed to a pressure in a range of about 1.5 bar and about 4 bar (a moderate pressure) and is thereafter heated to an interim temperature in a range of between about 300° C. and about 600° C. A reactant stream comprising at least one hydrocarbon and steam is heated to a temperature greater than 200° C. The oxygen containing stream, after having been heated, is introduced into a first heat exchanger located within a reaction vessel to heat the oxygen containing stream by indirect heat exchange with an oxygen depleted stream. Thereafter, the oxygen containing stream is introduced into a cathode side of a plurality of oxygen transport membranes located in a reaction section of the reaction vessel to separate oxygen from the oxygen containing stream. This separation produces permeated oxygen at an anode side of the oxygen transport membranes. The reactant stream is introduced into a second heat exchanger, located within the reaction vessel, to heat the reactant stream to a temperature in a range of between about 500° C. and about 750° C. by indirect heat exchange with a synthesis gas product stream. The reactant stream is introduced into a catalyst bed located at the anode side of the oxygen transport membranes and within the reaction section to promote the reaction of the permeated oxygen in a combination partial oxidation-reforming-water gas shift reaction to produce the synthesis gas product stream. The synthesis gas product stream is withdrawn from the reaction vessel after having been cooled through the indirect heat exchange with the reactant stream. The oxygen depleted gas is discharged from the reaction vessel after having been cooled through the indirect heat exchange with the oxygen containing stream.

The process uses an apparatus that contains all high temperature operations, including oxygen depleted gas to oxygen containing gas heat exchangers, synthesis gas product to reactant feed gas heat exchangers and OTM membrane reactor in a single shell, thereby lowering temperatures of the ends of the subject apparatus and avoiding additional high temperature process equipment enclosures. By exchanging heat between streams at similar pressure levels, design and construction of heat exchangers is substantially eased.

Preferably, the reactant gases of the reactant stream flow within the reaction section and therefore the catalyst bed in one of: axial flow, combined axial and transverse flow; spiral flow; radially-segmented cross-flow; and transverse-segmented cross-flow. Advantageously, at least one of the composition of the reactant gases, an oxygen permeate rate of the oxygen permeating through the oxygen transport membrane tubes, and the activity of catalyst located within the reaction section to promote reaction of the reactant stream and the permeated oxygen, is adjusted to balance locally the heat of the endothermic reforming reactions with the heats of exothermic oxidation and water gas shift reactions to the extent required for maintaining OTM surfaces within the desired operating temperature range, typically between 800 and 1100° C. This helps to prevent the oxygen transport membrane tubes from overheating.

A buffer gas zone can be located between the first heat exchanger and the reaction zone. A non-reactive gas is introduced into the buffer gas zone at a pressure slightly above that of the reactant stream to prevent leakage of reactant gas from the reactant gas stream into an oxygen containing stream.

The discharge temperature of the product synthesis gas stream from said product second heat exchanger is preferably maintained above 700° C. to inhibit metal dusting therein and the product synthesis gas stream is further cooled outside of the reaction vessel in an external heat exchanger to below about 400° C. against boiling water to inhibit metal dusting in the external heat exchanger. Alternately liquid water can be injected into the product synthesis gas stream after exiting the reaction section to partially cool the product synthesis gas stream by quenching, thereby to inhibit metal dusting in the second heat exchanger. Preferably the oxygen containing gas stream and the reactant gas stream has a temperature difference of greater than about 200° C. where they enter reaction section.

In an alternate arrangement the reactant stream, within the second heat exchanger, can initially be heated to a temperature of about 500° C. Thereafter, the reactant stream flows through a catalytic pre-reforming section in the second heat exchanger in which hydrocarbons having more than one carbon molecule are reformed into hydrogen and carbon monoxide to inhibit the formation of free carbon at higher temperatures and, is then heated to a temperature of above about above 700° C. The reactant gas can be subjected to a partial oxidation reaction with oxygen permeate prior to entering said catalyst bed. The reactant gas, after the reaction section, can undergo reforming reactions in the absence of oxygen permeate within an equilibrating section.

Advantageously, the process can be started by initiating start-up air flow to the reactor and injecting fuel into the stream leaving the cathode side of the reaction section to react with oxygen in the start-up air stream. This raises the temperature of that stream and by indirect heat transfer the temperature of the inlet air which then heats the OTM tubes. Injection of said fuel is continued until the oxygen transport membrane tubes reach operating temperature at which time the reactant stream is introduced into the second heat exchanger.

### BRIEF DESCRIPTION OF THE DRAWINGS

While the specification concludes with claims distinctly pointing out the subject matter that Applicants regard as their invention, it is believed the invention will be better understood when taken in connection with the accompanying drawings in which:

FIG. 1 is a schematic diagram of a process in accordance with the present invention for generating synthesis gas with the use of an apparatus incorporating integrated heat exchangers and an oxygen transport membrane reactor-separator assembly;

FIG. 2 is a cross-sectional view of the apparatus schematically illustrated in FIG. 1;

FIG. 3 is a cross-sectional view of the catalyst bed depicting spiral flow;

FIG. 4 is a cross-sectional view of the catalyst bed depicting radially-segmented cross-flow;

FIG. 5 is a cross-sectional view of the catalyst bed depicting transverse-segmented cross-flow;

FIG. 6 is an isometric view of the oxygen transport membrane tubes within the catalyst depicting varying length tubes;

FIG. 7 is a cross-sectional view of a tubesheet assembly used to support the oxygen ion transport membrane tubes in the apparatus shown in FIG. 1;

FIG. 8 is a cross-sectional view of a catalyst bed assembly of the apparatus shown in FIG. 1;

FIG. 9 is a cross-sectional view of a first heat exchanger used in the apparatus shown in FIG. 1;

FIG. 10 is a horizontal cross-sectional view of FIG. 1;

FIG. 11 is a detailed cross-sectional view of the buffer gas seal construction of the apparatus shown in FIG. 1; and

FIG. 12 is an alternative construction of the lower half of the apparatus of FIG. 2 with an outer jacket to preheat an oxygen containing stream.

### DETAILED DESCRIPTION

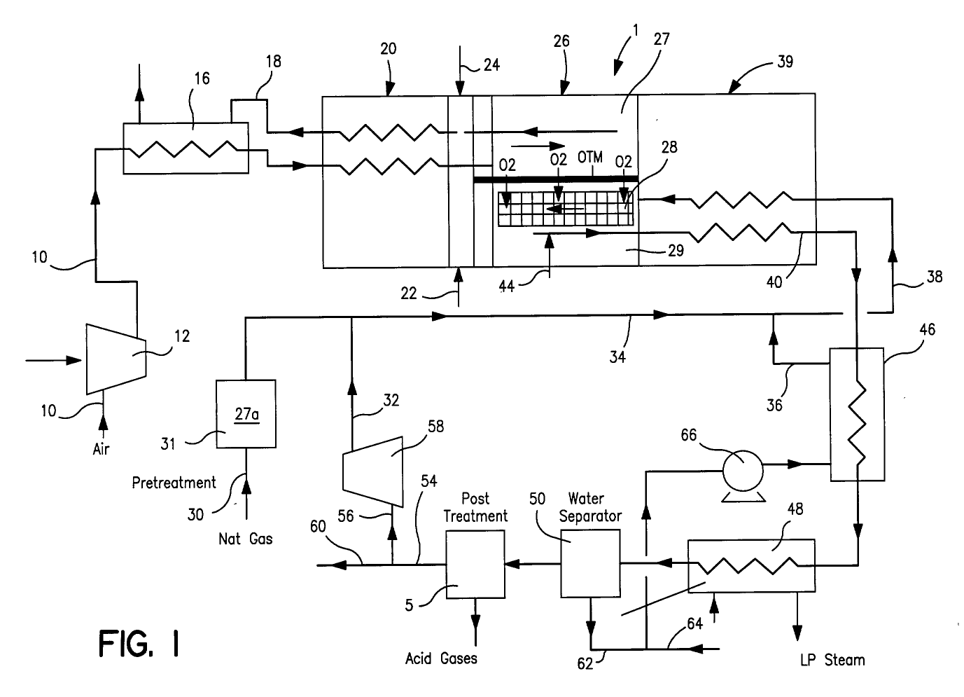

FIG. 1 represents a schematic of the syngas process using an integrated apparatus 1 of the present invention. An oxygen containing stream 10, formed of air or other oxygen containing gas is compressed by compressor 12 to a moderate pressure of 1.5 to 4 bar. Oxygen containing stream 10, is then heated to an intermediate temperature of about 200° C. to about 500° C. in an external heat exchanger 16 against an oxygen depleted stream 18. Oxygen containing stream 10 is thereafter introduced into an apparatus 1 where it is heated further in countercurrent flow in a first heat exchanger 20 by oxygen depleted stream 18 to above about 700° C. and preferably within at least 150° C. of the temperature of oxygen depleted stream 18 at the warm end of first heat exchanger 20. If required to raise the temperature of oxygen containing stream 10, optional fuel stream 22 can be introduced into apparatus 1 to react with residual oxygen in oxygen depleted stream 18 and added oxygen by way of optional added air stream 24.

Oxygen containing stream 10 is then introduced into reaction section 26 and to cathode sides 27 of oxygen transport membrane tubes which will be discussed in more detail hereinafter. In oxygen transport membrane tubes, oxygen molecules dissociate and are transported as oxygen ions across the oxygen transport membrane tubes to react with part of the reactant from stream 38 at the anode 29 to produce oxidation products which then react with reactant within a catalyst bed 28, also located in reaction section 26 and at anode sides 29 of the oxygen transport membrane tubes.

A hydrocarbon source containing one or more species of hydrocarbons, such as natural gas, can be introduced, as a natural gas stream 30 having a pressure of between about 10 bar and about 40 bar, into a pretreatment section 31, which may consist of a desulfurization system to remove objectionable sulfur compounds after some preheating against other waste heat sources. Natural gas stream 30 is then preferably mixed with a recycle stream 32 consisting of hydrogen, carbon monoxide, carbon dioxide and unreacted methane. The resultant combined stream 34, or the natural gas stream 30, if no recycle stream is used, is then further combined with steam 36 to form reactant stream 38. The recycle stream can contain recycled synthesis gas product and off gases from downstream reactions. Reactant stream 38 enters apparatus 1 to be heated in a second heat exchanger 39 to an intermediate temperature tailored to a maximum permissible level for avoiding free carbon formation of between about 500° C. and about 750° C., depending on composition.

In the reaction section 26 of apparatus 1, the reactant stream 38 is heated rapidly by oxidation reactions with permeated oxygen to a preferred temperature ranging from between about 800° C. and about 1050° C. and the constituents of reactant stream 38 and permeated oxygen participate in a combination partial oxidation-reforming-water gas shift reaction to produce a synthesis gas product stream 40.

Except near the reactant entry, it is desirable to control the combined reactions to be near energy neutral and thus, control membrane temperature of the oxygen transport membrane tubes, by adjusting reactant feed composition (e.g. increased steam content will favor the endothermic steam reforming reaction), oxygen permeation (e.g. by varying the pressure or flow rate of the oxygen containing gas stream 10), morphology of a composite membrane, and or catalyst activity (e.g. by varying surface area or Ni loading of the reforming catalyst).

Synthesis gas product stream 40 is cooled against reactant stream 38 in second heat exchanger 39. It is desirable to optionally maintain the wall temperature of second heat exchanger 39 at below about 400° C. to avoid metal dusting, and thereby avoid use of expensive materials in said exchanger, by having higher heat transfer film coefficients on the reactant feed side than on the synthesis gas product side. This can be accomplished by having higher mass velocities, or in laminar flow smaller channel dimensions, on the reactant feed side than on the product gas side. This can limit the temperature to which reactant stream 38 can be heated prior to entry into the reaction section 26. To avoid cooling the oxygen transport membrane tubes near the entry point thereof to a temperature too low for effective ion transport, the local temperature of the oxygen containing gas stream 10 at the opposite side of the membrane should be at a substantially higher level than that of reactant stream 38. It can also be advantageous to optionally omit catalyst in reaction section 26 near the entry point of reactant stream 38 thus favoring oxidation reactions and rapid heating of the reactants in the entry portion of the reaction section 26.

An optional alternate way of avoiding metal dusting is to cool synthesis gas product stream 40 by injection of quench water stream 44 therein near the point at which synthesis gas product stream 40 is discharged from reaction section 26. Another optional alternative for avoiding metal dusting is to cool synthesis gas product stream 40 in second heat exchanger 39 to a temperature of above about 700° C. only and shift further cooling to a boiler 46 where it is easy to maintain wall temperatures below 400° C. because of boiling water on the low temperature side.

Typically there is sufficient sensible heat available in synthesis gas product stream 40 after leaving second heat exchanger 39 for raising the required quantity of reactant stream 38 in boiler 46 at the desired process pressure level. Synthesis gas product stream 40, after exiting boiler 46 enters waste heat boiler 48 where the synthesis gas product stream 40 is further cooled and most of the contained steam condensed against water boiling at a lower pressure level. Following waste heat boiler 48, the synthesis gas product stream 40 is introduced into a water separator 50 and is further treated in post treatment section 52 to produce a treated product stream 54. Post treatment can consist of acid gas removal and hydrogen to carbon monoxide ratio adjustment by known means.

A portion 56 of the treated product stream 54 is recirculated as recycle stream 32 by means of a recycle compressor 58 to join natural gas stream 30. Recycle stream 32 can also be joined by recycle streams from down stream reactors. Optionally some carbon dioxide, separated in post treatment section 52, is added to recycle stream 32 (not shown) to adjust the carbon to steam ratio in the reactant stream 38 and the hydrogen to carbon monoxide ratio of the synthesis gas product. Final synthesis gas product stream 60 is delivered to downstream processes, such as methanol production, or Fischer-Tropsch processes for producing liquid fuels.

Steam stream 36 is generated by taking water condensate stream 62 from water separator 50 and make-up water stream 64, pumping it to the desired pressure in a pump 66 and converting it to steam in boiler 46. Steam stream 36 joins natural gas stream 30 to form reactant stream 38. Steam generated in waste heat boiler 48 can be used for powering steam turbine drivers for resident compressors or other on site uses.

Optionally, second heat exchanger 39 is divided into two sections with a catalytic pre-reformer located between the two sections. The catalytic pre-reformer, which operates at a temperature of between about 400° C. and about 500° C. raises the permissible temperature to which reactant stream 38 can be heated prior to entry into the reaction section 26 without free carbon formation. This option is especially useful if the reactant feed contains hydrocarbons heavier than methane which are then converted in the pre-reformer. Optional added air stream 24 and optional fuel stream 22 are especially useful in this case since the reaction of fuel with contained oxygen adds heat capacity to oxygen containing stream 10 for providing at least some of the heat required by the endothermic reaction in the pre-reformer.

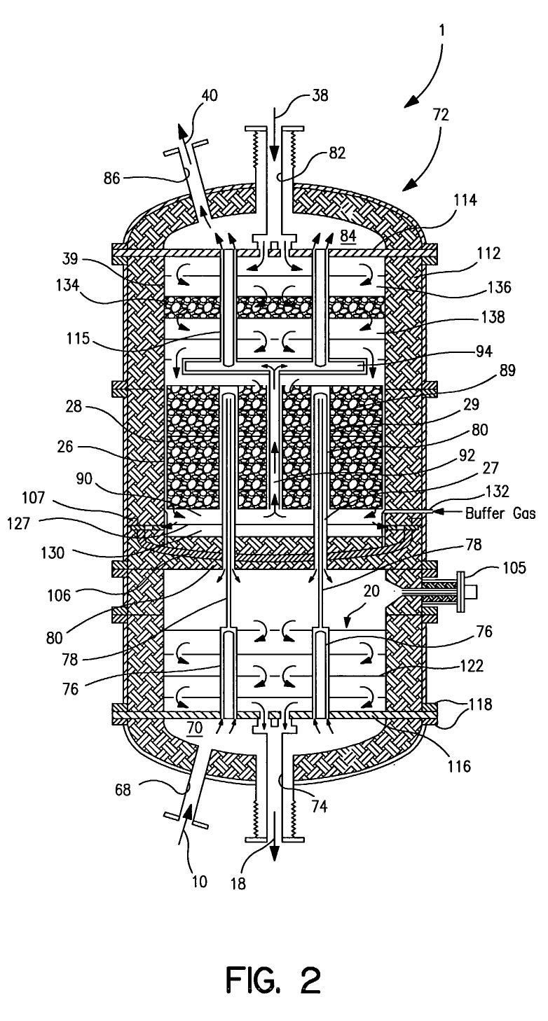

With reference to FIG. 2, oxygen containing stream 10 is fed via entrant passage 68 into a lower head 70 of a reactor vessel 72. Before entering the reaction vessel 72, oxygen containing stream 10 is pressurized and heated as discussed above. In the lower head 70 and first heat exchanger 20, the pressurized fed air is heated to a temperature range of about 700° C. to about 1000° C. by the heated oxygen depleted stream 18 (also called the retentate or cathodic effluent) leaving the reaction vessel 72 by discharge passage 74.

Heated and compressed feed air from oxygen containing stream 10 flows up heat exchanger tubes 76 and into open-ended lance tubes 78. The top of each lance tube 78 is covered by an oxygen transport membrane tube 80 of the type that is closed at one end and open at the other end. At the open end of each lance tube 78, the hot compressed air discharges against the inside of surface of the oxygen transport membrane tube 80 and then flows downward. As the hot, compressed air travels downward in the annulus formed between the lance tube 78 and the oxygen transport membrane tube 80, oxygen in the air is ionized and permeates radially across the membrane in ionic form to the anode side 29 where it reacts with reactant gas of the reactant stream. The reaction products and possibly a minor amount of residual oxygen will flow into catalyst bed 28. At the lower end of the annulus, oxygen depleted air flows through the first heat exchanger 20 and lower head 70 before exiting through discharge passage 74 as oxygen depleted stream 18.

As viewed in this FIG. 2, in the upper portion of the reaction vessel 72, reactant stream 38 is fed via upper entrant passage 82 into upper head 84 and into second heat exchanger 39 where it is heated to a temperature range of up to about 750° C. by means of synthesis gas product stream 40 (also called the anode effluent) leaving the reactor vessel 72 by means of discharge passage 86. Reactant stream 38 enters apparatus 1 at a pressure of about 100 psig to about 600 psig.

Reactant stream 38 leaves second heat exchanger 39 and flows into the catalyst bed 28 and traverses the catalyst bed 28 in either axial flow, cross-counter flow, or spiral cross-flow. It contacts the oxygen permeate produced by oxygen transport membrane tubes 80 into the catalyst bed 28. The preferred hydrocarbon gas is natural gas containing methane and other light hydrocarbons.

Both exothermic partial oxidation reactions, as well as endothermic reforming reactions, will occur on anode side 29 of oxygen transport membrane tubes within the catalyst bed 28. The partial oxidation reaction for methane is shown in Equation 1. The steam reforming reaction for methane is shown in Equation 2. Additional conversion of carbon monoxide may occur with the exothermic water gas shift reaction, Equation 3.

CH₄+½O₂CO+2H₂ (1)

CH₄+H₂OCO+3H₂ (2)

CO+H₂OCO₂+H₂ (3)

The scope of the present invention also includes reforming reactions between methane and CO₂ as indicated by equation (4). The H₂/CO ratio in the syngas product can be adjusted somewhat by operating with various levels of steam-to-carbon ratios in the process feed. Similarly, the overall thermal balance between exothermic and endothermic reactions can be adjusted by altering the steam-to-carbon ratio.

CH₄+CO₂2CO+2H₂ (4)

As reactant stream 38 flows through the catalyst bed 28 containing reaction section, it reacts with oxygen permeate. The oxygen permeate at the anode side 29 of a dense membrane film of oxygen transport membrane tubes 80 reacts with reactant gas supplied by reactant stream 38 in an oxidation reaction. The oxidation reaction products flow through an optional porous shroud tube 88 that surrounds each oxygen transport membrane tube 80 and into the catalyst bed 28. These gases react with the reactant stream 38 to form a synthesis gas (CO+H₂) as it flows through the catalyst bed 28.

The process gas flow path within catalyst bed 28 can take various configurations. FIG. 2 depicts an axial flow pattern with process gas flow both downward and transversely through the bed. This is accomplished by the indicated arrangement of transversely segmented baffle plates 89. Syngas is collected in a lower plenum 90 below the catalyst bed 28 and then transported up through a syngas delivery tube or conduit 92 to an upper plenum 94 above the catalyst bed 28. The syngas then enters second heat exchanger 39 for heat recovery as previously described.

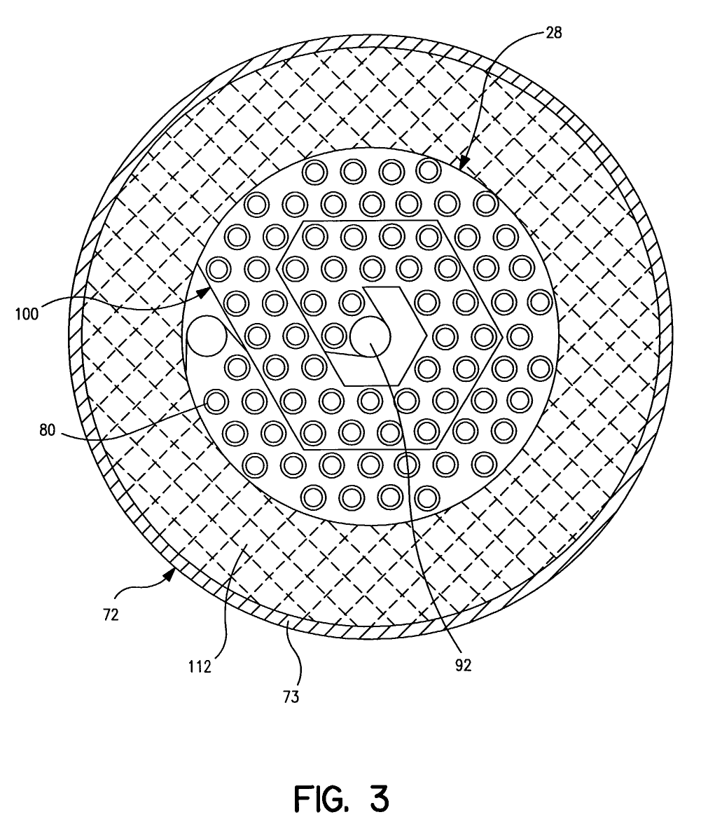

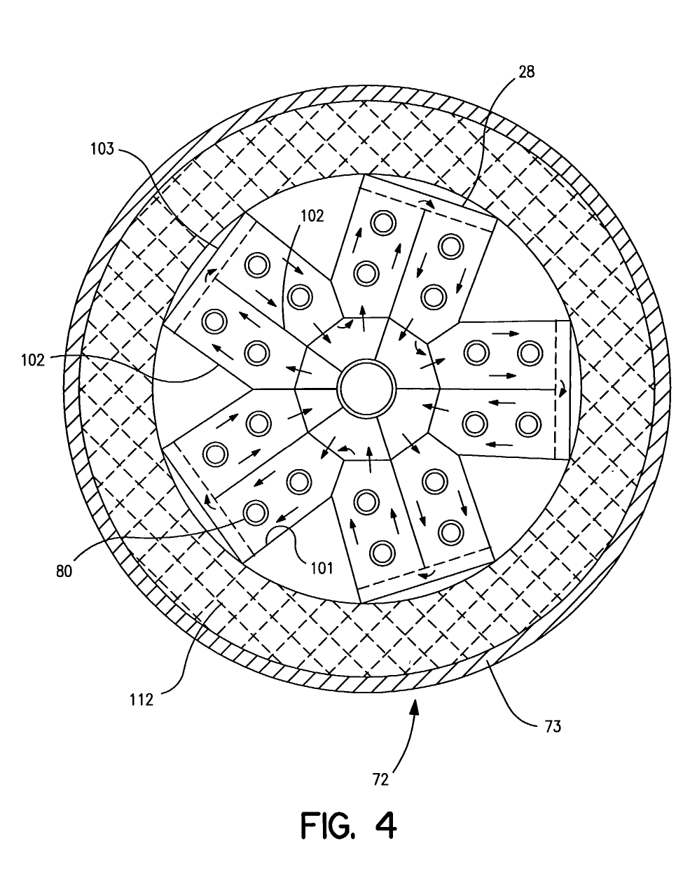

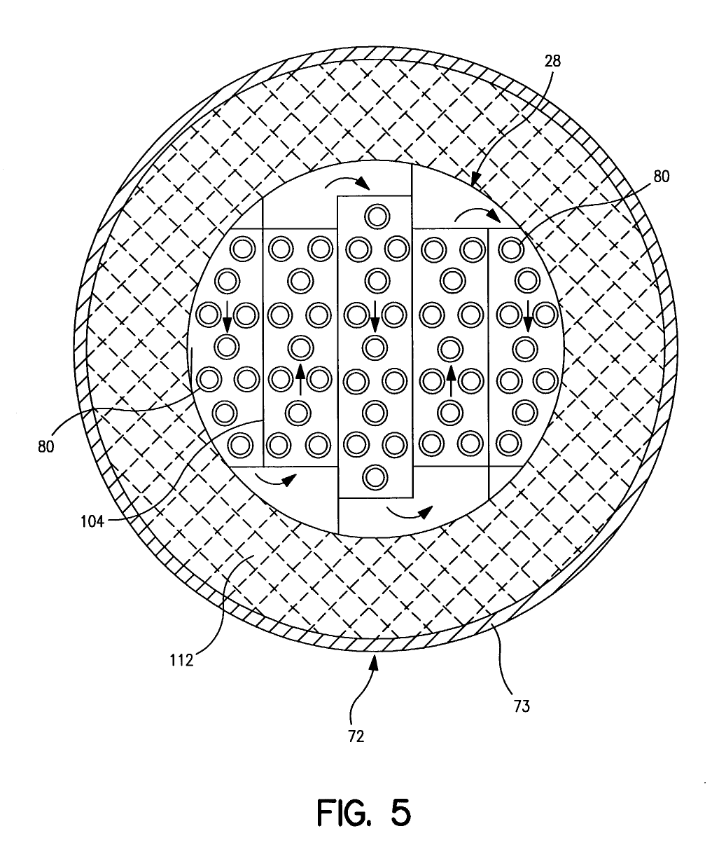

An alternative flow arrangement could be produced by deleting baffle plates 89 so that flow through the catalyst bed 29 were predominantly in the axial direction. A further alternative would be combined axial-spiral flow. Process gas would flow axially between stages and then in spiral fashion directed by baffles 100, either inward or outward at each successive stage. This pattern is depicted in FIG. 3. Another flow alternative is a radially-segmented cross-flow configuration where the process gas would flow transversely across the OTM tubes in segmented catalyst chambers 101 defined between radial walls 102 and vertical end plates 103 connecting radial walls 102. Each chamber could contain one or more oxygen transport membrane tubes 80. Process gas flow collects in intermediary plenums that extend axially over the entire length of the catalyst bed between end walls 103 and catalyst contained within each segmented catalyst chamber 101. Each plenum provides a means for gas mixing between successive catalyst chambers. FIG. 4 depicts this configuration. The number of successive catalyst chambers could be any number greater or equal to one. These chambers could be spatially oriented in a somewhat radial manner as shown in FIG. 4 or in other transverse configurations such as the transverse, staggered, vertical arrangement of baffle plates 104 illustrated in FIG. 5.

The catalyst bed 28 consists of packed particles of a steam reforming catalyst known generally to be used in steam-methane reforming (SMR) hydrogen production plants. The catalyst typically contains an active nickel layer deposited on a compatible substrate carrier material, e.g. alumina. The particles can take on many geometric shapes but generally are selected to provide sufficient contact area for the process gas while minimizing the pressure drop for gas flow. The radially-segmented cross-flow pattern provides a useful means to vary the catalyst activity between the sequential catalyst chambers to promote the desired process gas conversion to syngas in a thermally-neutral manner without experiencing individual hot spots or quenching zones.

Another means of achieving the desired effect of varying the process gas conversion for axial flow reactors with upward bed flow would be to use oxygen transport membrane tubes 80a of varying length as depicted in FIG. 6. This would provide a means of altering the oxygen released-per-unit volume within the catalyst bed 28, and hence, emphasize the partial oxidation reactions over the reforming reactions in areas with higher tube density.

With reference again to FIG. 2, a commercially-available nozzle-mix combustion burner 105 is used to provide heat to the reactor during startup. Air and natural gas are supplied to burner 105 which fires into a low pressure air chamber directly below a tubesheet 106 that supports oxygen transport membranes 80. Heating rate for the reactor vessel 72 and internal components including the oxygen transport membrane tubes 80 is controlled by both the firing rate of the burner and the feed air flow rate. When steady state operating temperatures have been achieved and actual syngas production begins, the overall reaction will become exothermic and no longer require thermal input from the burner 104.

This reactor design provides four internal component assemblies that can freely expand or contract independently from each other without inducing mechanical loads and resultant material stresses.

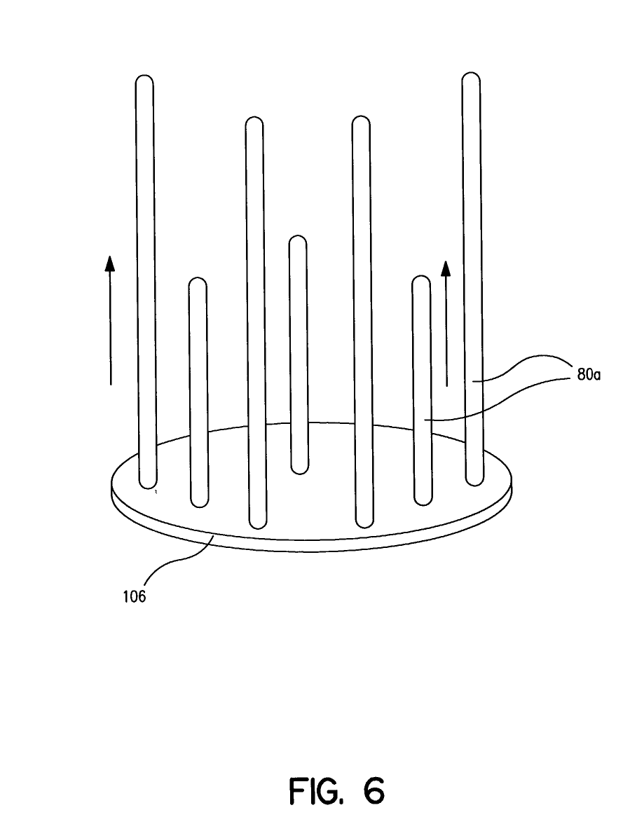

Referring to FIG. 7, one internal component assembly of Apparatus 1, is the group of closed-one-end OTM tubes 80 that are sealed at their open ends to fixed tubesheet 106. The oxygen transport membrane tubes 80 will grow vertically upward without constraint from thermal expansion and compositional dilation. Tubesheet 106 is connected to an outer shell 73 of the reactor vessel 72 by a flange 107. Oxygen transport membrane tubes 80 are connected to tubesheet 106 by means of a tube seal 126 to be discussed hereinafter.

Any ceramic membrane material or combination of materials capable of conducting ions and electrons may be used to fabricate oxygen transport membrane tubes 80. Metal oxides having mixed conductivity (ion and electron conductivity) and dual phase mixtures of ion conducting metal oxides and electron conducting metal oxides or metals may be used. Mixed conducting perovskites, brownmillerites and dual phase metal-metal oxide combinations disclosed in the references cited above may be particularly suitable. Oxygen transport membrane tubes 80 can have dense walls or be of the composite type in which a dense film is supported by a porous matrix preferentially at the reaction or anode side 29. In this case at least an outer layer of the porous support can contain catalyst. Thus at least a portion of the endothermic reforming reaction is positioned in a closer heat transfer relationship with the oxidation reaction at the anode side 29 of the thin film. It is preferable to use thin, strong membranes that have high oxygen vacancy concentrations for high oxygen flux, yet have sufficient tube strength to maintain an acceptable reliability. This invention could also be practiced with other membrane structures (e.g. flat plates of ceramic membrane material) instead of tubes. It may also be desirable for some applications to coat the membrane material with a porous ion and electron conducting coating or the like on the cathode and anode sides to increase surface exchange area and to improve its mass transfer capability.

The ceramic membrane may comprise any material that selectively conducts oxygen ions. The following table gives several examples of such materials.

TABLE I
Mixed Conducting Solid Electrolytes

| | Material Composition | |
|---|---|---|
| 1. | (La₁₋ₓSrₓ) (Co_{1-y}Fe_{y}) O_{3-δ} (0 ≦ x ≦ 1, | |
| | 0 ≦ y ≦ 1, δ from stoichiometry) | |
| 2. | SrMnO_{3-δ} (δ from stoichiometry) | |
| | SrMn_{1-y}Co_{y}O_{3-δ} (0 ≦ y ≦ 1, δ from stoichiometry) | |
| | Sr₁₋ₓNaₓMnO_{3-δ} (0 ≦ x ≦ 1, δ from stoichiometry) | |
| 3. | BaFe_{0.5}Co_{0.5}YO₃ | |
| | SrCeO₃ | |
| | YBa₂Cu₃O_{7-δ} (0 ≦ δ ≦ 1, δ from stoichiometry) | |
| 4. | La_{0.2}Ba_{0.8}Co_{0.8}Fe_{0.2}O_{2.6}; | Pr_{0.2}Ba_{0.8}Co_{0.8}Fe_{0.2}O_{2.6} |

| | |
|---|---|
| 5. | AₓA′ _{x′}A″ _{x″}B_{y}B′ _{y′}B″ _{y″}O_{3-δ} |
| | (x, x′, x″, y, y′, y″ all in 0-1 range) |
| | Where: A, A′, A″ = from groups 1, 2, 3 and f-block |
| | lanthanides |

B, B′, B″ = from d-block transition metals
δ from stoichiometry

| | | | |
|---|---|---|---|
| 6. | (a) Co—La—Bi type: | Cobalt oxide | 15-75 mole % |
| | | Lanthanum oxide | 13-45 mole % |
| | | Bismuth oxide | 17-50 mole % |
| | (b) Co—Sr—Ce type: | Cobalt oxide | 15-40 mole % |
| | | Strontium oxide | 40-55 mole % |
| | | Cerium oxide | 15-40 mole % |
| | (c) Co—Sr—Bi type: | Cobalt oxide | 10-40 mole % |
| | | Strontium oxide | 5-50 mole % |
| | | Bismuth oxide | 35-70 mole % |
| | (d) Co—La—Ce type: | Cobalt oxide | 10-40 mole % |
| | | Lanthanum oxide | 10-40 mole % |
| | | Cerium oxide | 30-70 mole % |
| | (e) Co—La—Sr—Bi type: | Cobalt oxide | 15-70 mole % |
| | | Lanthanum oxide | 1-40 mole % |
| | | Strontium oxide | 1-40 mole % |
| | | Bismuth oxide | 25-50 mole % |
| | (f) Co—La—Sr—Ce type: | Cobalt oxide | 10-40 mole % |
| | | Lanthanum oxide | 1-35 mole % |
| | | Strontium oxide | 1-35 mole % |
| | | Cerium oxide | 30-70 mole % |

| | |
|---|---|
| 7. | Bi_{2-x-y}M′ ₓM_{y}O_{3-δ} (0 ≦ x ≦ 1, 0 ≦ y ≦ 1, |
| | δ from stoichiometry) |
| | where: M′ = Er, Y, Tm, Yb, Tb, Lu, Nd, Sm, Dy, Sr, Hf, Th, |
| | Ta, Nb, Pb, Sn, In, Ca, Sr, La and mixtures thereof |
| | M = Mn Fe, Co, Ni, Cu and mixtures thereof |
| 8. | BaCe₁₋ₓGdₓO_{3-x/2} where, x equals from zero to about 1. |
| 9. | One of the materials of AₛA′ ₜBᵤB′ ᵥB″ _{w}Oₓ family whose |
| | composition is disclosed in U.S. Pat. No. 5,306,411 |
| | (Mazanec et al.) as follows: |
| | A represents a lanthanide or Y, or a mixture thereof; |
| | A′ represents an alkaline earth metal or a mixture |
| | thereof; |
| | B represents Fe; |
| | B′ represents Cr or Ti, or a mixture thereof; |
| | B″ represents Mn, Cc, V, Ni or Cu, or a mixture |
| | thereof; |
| | and s, t, u, v, w, and x are numbers such that: |
| | s/t equals from about 0.01 to about 100; |
| | u equals from about 0.01 to about 1; |
| | v equals from zero to about 1; |
| | w equals from zero to about 1; |
| | x equals a number that satisfies the valences of the A, |
| | A′, B, B′, |
| | B″ in the formula; and 0.9 < (s + t)/(u + v + w) < 1.1 |
| 10. | One of the materials of La₁₋ₓSrₓCu_{1-y}M_{y}O_{3-δ family, where:} |
| | M represents Fe or Co; |
| | x equals from zero to about 1; |
| | y equals from zero to about 1; |
| | δ equals a number that satisfies the valences of La, |
| | Sr, Cu, and M in the formula |
| 11. | One of the materials of Ce₁₋ₓAₓO_{2-δ} family, where: |
| | A represents a lanthanide, Ru, or Y; or a mixture |
| | thereof; |
| | x equals from zero to about 1; |
| | δ equals a number that satisfies the valences of Ce and |
| | A in the formula |
| 12. | One of the materials of Sr₁₋ₓBiₓFeO_{3-δ} family, where: |
| | A represents a lanthanide, or Y, or a mixture thereof; |
| | x equals from zero to about 1; |
| | δ equals a number that satisfies the valences of Ce and |
| | A in the formula |
| 13. | One of the materials of SrₓFe_{y}Co_{z}O _{3-δ} family, where: |
| | x equals from zero to about 1; |
| | y equals from zero to about 1; |
| | δ equals a number that satisfies the valences of Sr, Bi |
| | and Fe in the formula |
| 14. | Dual phase mixed conductors (electronic/ionic) |
| | (Pd)_{0.5}/(YSZ)_{0.5} |
| | (Pt)_{0.5}/(YSZ)_{0.5} |
| | (LaCr_{1-y}Mg_{y}O_{3-δ})_{0.5} (YSZ)_{0.5} |
| | (In_{90%}Pt_{10%})_{0.6}/(YSZ)_{0.5} |
| | (In_{90%}Pt_{10%})_{0.5}/(YSZ)_{0.5} |
| | (In_{95%}Pr_{2.5%}Zr_{2.5%})_{0.5}/(YSZ)_{0.5} |
| | Any of the materials described in 1-13, to which a high |
| | temperature metallic phase (e.g., Pd, Pt, Ag, Au, Ti, Ta, |
| | W) is added |

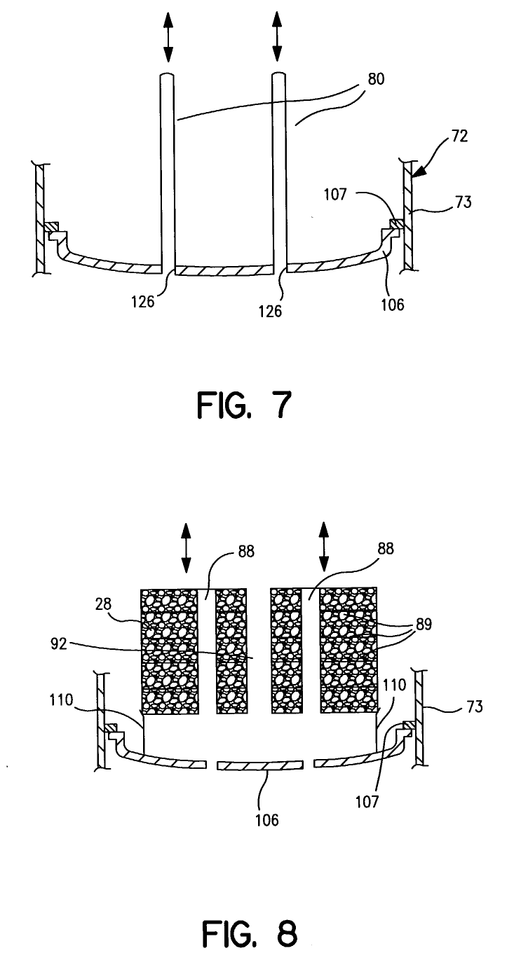

Referring to FIG. 8, oxygen transport membrane tubes 80 will slide freely within reaction section 26 defined by catalyst bed 28 interspersed with optional porous shroud tubes 88. Shroud tubes 88 surround each oxygen transport membrane tube 80 and form a means of gas communication between the oxygen transported through the ceramic membrane wall and the catalyst bed 28. The optional shroud tubes 88 also provide a means to remove and re-insert oxygen transport membrane tubes or remove and replace catalyst without catalyst bed-tube interaction. The catalyst bed 28 is supported from the fixed oxygen transport membrane tubesheet 106 below by means of supports 110 and can grow vertically upward as required from thermal expansion without constraint.

Another internal component assembly consists of second heat exchanger. Second heat exchanger 39 is contained entirely within the reaction vessel 72 which is internally insulated with ceramic fiber insulating blankets 112. Second heat exchanger 39 is supported from a fixed tubesheet 114 that separates the incoming feed stream from the exiting product stream. As the temperature profile in the heat exchanger 39 is established between the cooler end at the top and the hotter end at the bottom, the heat exchanger 39 is free to expand axially toward the oxygen transport membrane tubes 80. As shown in FIG. 2, reactant stream 38 is directed to flow on the shell product side of the heat exchanger tubes 115 of second heat exchanger 39 and collect in an open space above the catalyst bed 28. The synthesis gas product forming synthesis gas product stream 40 flows through the inside of the heat exchanger tubes.

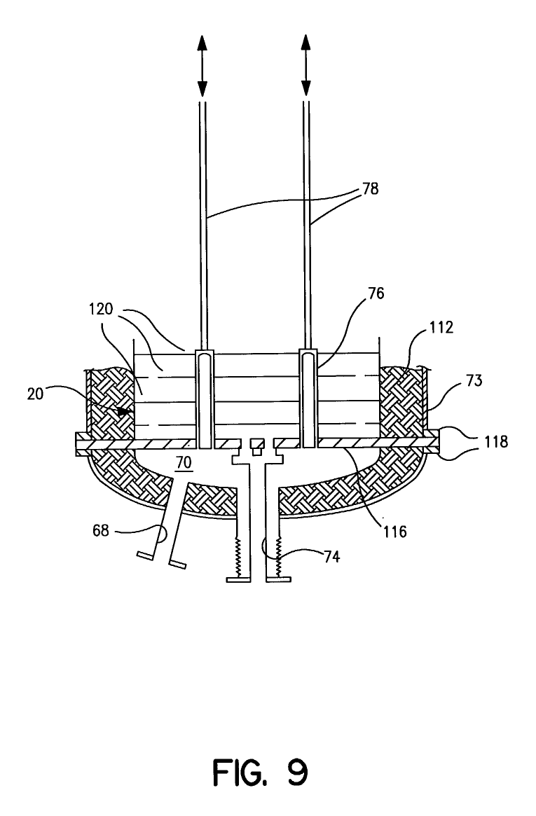

Referring to FIG. 9, a further internal component assembly that has freedom to grow from thermal expansion is first heat exchanger 20. First heat exchanger 20, which is supported within the reactor by fixing its tubesheet 116 between two reactor flanges 118, provides a means to recover heat from the hot oxygen depleted stream 18 exiting from the inside of the oxygen transport membrane tubes 80. First heat exchanger 20 is separated into stages that are divided by baffles 120 which direct the shell side flow in a cross-counter flow fashion with respect to the tube side flow. Oxygen depleted stream 18 transfers heat to the incoming oxygen containing stream 10 as it flows through first heat exchanger 20. As depicted in FIG. 1, the oxygen containing stream 10 is delivered to the inside of the oxygen transport membrane tubes 80 by small diameter open-ended lance tubes 78 that extend internally to a position near their capped ends. The axial clearance between these open-ended lance tubes 78 and the inside surface of the cap of the oxygen transport membrane tubes 80 will accommodate the thermal growth of first heat exchanger 20 vertically upward.

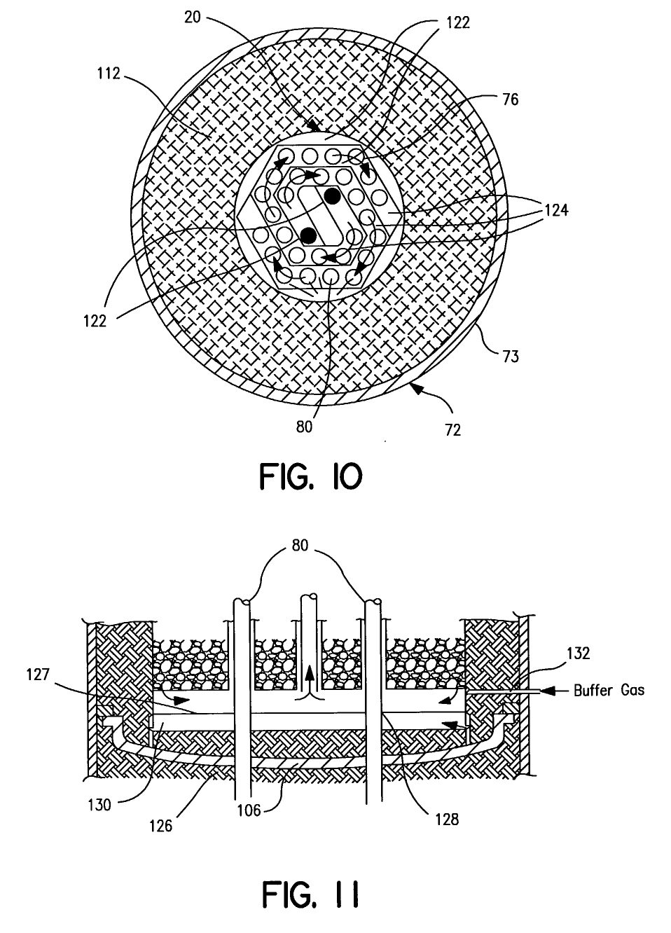

The heat exchanger designs are disclosed more fully in the cross-sectional view shown in FIG. 10. As an example, first heat exchanger 20 is surrounded by ceramic fiber blanket insulation 112 and reaction vessel wall 73 of the reaction vessel 72. Spiral baffles 122 direct the flow of gas in cross-counter flow or in spirally-oriented flow passages 124. For the latter, vertical-oriented heat exchanger tubes 76 are shown within flow passages 124, penetrating spiral baffles 122 to direct flow axially. Higher convection coefficients can be achieved by confining the shell-side fluid streams into defined channels and controlling the cross-sectional flow area. Additionally, spiral baffles 122 can act as extended surface to the tube walls of heat exchanger tubes 76 for radiation heat transfer. The spiral flow design can achieve larger overall heat transfer coefficients than traditional shell-and-tube heat exchangers with cross-flow baffles.

The oxygen transport membrane tube-to-tubesheet seal 126 requires sealing between a high pressure fuel stream and a low pressure oxygen containing stream at the point where the tube is joined to the high pressure tubesheet. Any leakage of high temperature fuel into an oxidant stream is detrimental to the safe operation of the reactor. Localized combustion jets can form that may damage the seal 126, the oxygen transport membrane tubes 80, or the tubesheet 116.

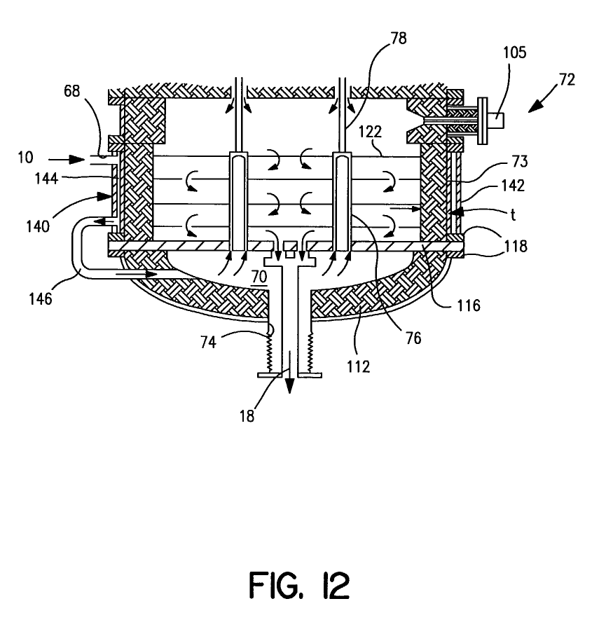

FIG. 11 depicts a means to limit this undesirable communication by isolating the fuel and air streams with an intermediate buffer gas. The buffer gas should not support an oxidation reaction with fuel. Gases such as nitrogen, carbon dioxide, or steam would be acceptable candidates with preference depending on seal material selection. Detailed description of suitable seal designs is given in U.S. Pat. No. 6,139,810, FIGS. 3 and 4. Sealing is accomplished in two stages with a buffer gas between seals 126 at tubesheet 106 and 128 at plate 127 which separates the buffer zone 130 from the reaction products. The buffer zone or chamber 130 adjacent to the seal 126 would be filled with the buffer gas through passageway 132 and maintained at a pressure slightly higher than the fuel stream. Leakage of this buffer gas into the high pressure fuel stream could be controlled by minimizing the pressure differential and/or utilizing a second set of mechanical seals for seal 128 around the oxygen transport membrane tubes 80. If steam and or CO₂ are used as a buffer gas, a small amount of leakage is inconsequential and can be tolerated, since these gases are also constituents of the reacting stream. In this case employing a flow restriction in the form of close circumferential clearances between the OTM tubes and the openings in plate 127 or non contact labyrinth seals can be adequate for limiting leakage to permissible levels. Buffer gas leakage into the air stream will depend on the quality of seal 126 between the oxygen transport membrane tube 80 and the tubesheet 106.

Alternative ways of practicing the present invention include previously described variations in internal process gas and air flow patterns, configuring the catalyst in different forms, variations in heat exchanger design, excluding either of the two heat recovery heat exchangers, and including an annular jacket around a portion of the reaction outer vessel wall 73 for additional heat recovery and feed air pre-heating.

Catalyst could also be deployed in rigid open-cell monoliths that are shaped to take advantage of the geometry of the closely-packed oxygen transport membrane tubes 80. Reticulated foams or other means of providing high surface area support for catalyst could be used. Possible shapes include individual hollow cylindrical sleeves that could be slipped over the external surface of the oxygen transport membrane tubes, interlocking honeycomb pieces that would slip over the oxygen transport membrane tubes and fit with each other to retain a structure similar to a packed bed, or individual extruded rods that could be inserted axially between adjacent oxygen transport membrane tubes.

The internal heat exchanger designs could also be configured in other ways including conventional segmental or “disk and doughnut” baffling for shell-side flow patterns. The use of these techniques may reduce the shell-side heat transfer coefficient from the preferred axial-spiral configuration described earlier.

With reference again to FIG. 2, when reactant stream 38 includes higher hydrocarbons other than methane, it is advantageous to include a pre-reforming process step to avoid operational problems resulting from carbon formation or coking. To such end a pre-reformer consisting of a catalyst bed 134 is integrated with Apparatus 1 in a way such that first heat exchanger 20 is split into two separate sections 136 and 138 with one on each side of catalyst bed 134. The first section 136 preheats to the oxygen containing gas stream 10 to raise its temperature up to the level normally associated with pre-reformers, about 450° C. to about 550° C. The second section 138 provides the final heat exchange to bring the pre-reformed gas up to a temperature range of up to about 700° C. and about 1000° C.

FIG. 12 depicts an optional annular jacket 140 for recovering additional heat from Apparatus 1 that would otherwise be part of the environmental heat leak. A portion of the reaction vessel wall 73 can be jacketed with a thin metallic skin 142 to form an annular flow passage 144 for preheating the oxygen containing stream 10. The preheated oxygen containing stream 10 can then be directed, via passageway 146 into the first heat exchanger 10 for further heating. This jacketed approach requires that the internal insulation thickness “t” of this portion of the pressure vessel be reduced slightly to raise the wall temperature and enhance the temperature difference and improve heat transfer. The temperature of the reaction vessel wall 73 must not rise to a level that reduces the corresponding material strength below what is required to safely contain the internal reactor pressure.

While the invention has been described above with reference to specific embodiments thereof, it is apparent that many changes, modifications, and variations can be made without departing from the inventive concept disclosed herein. Accordingly, it is intended to embrace all such changes, modifications and variations that fall within the spirit and broad scope of the appended claims.

We claim:

1. An apparatus for the production of synthesis gas including:
a reaction vessel;
a first heat exchanger, located within one end of said reaction vessel, to heat a preheated oxygen containing stream by indirect heat exchange with an oxygen depleted stream;
a second heat exchanger, located within the other end of said reaction vessel, to heat a reactant stream comprising at least one hydrocarbon and steam by indirect heat exchange with a synthesis gas product stream;
a plurality of oxygen transport membranes located in a reaction section of the reaction vessel to separate oxygen from the oxygen containing stream, thereby to produce permeated oxygen at anode sides of the oxygen transport membrane tubes, the oxygen transport membranes having cathode sides in communication with the first heat exchanger to receive the oxygen containing stream;
the reaction section in communication with the second heat exchanger so that the reactant stream is introduced to the anode side of oxygen transport membranes in said reaction section;
a catalyst bed located within the reaction section to promote the reaction of the permeated oxygen in a combination partial oxidation-reforming-water gas shift reaction to produce the synthesis gas product stream;
first entrant and discharge passages in communication with the first heat exchanger and second entrant and discharge passages in communication with the second heat exchanger to allow for passage of the oxygen containing and oxygen depleted streams and for passage of the reactant and synthesis gas product streams, respectively, to and from the reactor vessel; and
the first heat exchanger, the second heat exchanger, and the oxygen transport membrane tubes each supported within the reactor vessel independently of one another so that each can independently expand or contract.

2. The apparatus of claim 1, wherein said reactant section has baffle plates configured to produce a flow of the reactant gas through the reactant section and therefore the catalyst bed of one of: axial flow, cross-flow, combined axial and transverse flow; spiral flow; radially-segmented cross-flow; and transverse-segmented cross-flow.

3. The apparatus of claim 1, wherein said oxygen transport membranes are tubular and said reactant section has perforated shroud tubes surrounding said oxygen transport membrane tubes.

4. The apparatus of claim 1, wherein the oxygen transport membranes are formed from oxygen transport membrane tubes; and an inert buffer gas zone is located between the reaction section and seal locations at the open ends of the oxygen transport membrane tubes to allow introduction of a non-reactive gas therein at a pressure greater than that of the reactant zone to prevent leakage of reactant gas from the reactant stream into the oxygen containing stream.

5. The apparatus of claim 1, wherein each of the first and second heat exchangers has a heat exchanger tubesheet connected to the reactor vessel and a plurality of tubes connected to said tubesheet for internal passage of said synthesis gas product stream and said oxygen containing stream, respectively.

6. The apparatus of claim 5, wherein said oxygen transport membranes are of tubular configuration having closed and open ends and are supported at their said open ends from a support tubesheet located between the heat exchanger tubesheets.

7. The apparatus of claim 5, wherein said tubes divide said first and second heat exchangers into oxygen containing gas feed and oxygen depleted gas and feed gas and product gas sides, on opposite sides of said tubes, respectively and said second heat exchanger is configured such that higher mass velocities exist on said feed gas side than on said product gas side.

8. The apparatus of claim 1, wherein said second heat exchanger has first and second stages with a catalytic pre-reforming section located between said stages containing a pre-reforming catalyst to pre-reform hydrocarbons with more than one carbon molecules to in turn form hydrogen and carbon monoxide therefrom.

9. The apparatus of claim 1, wherein said reaction section has a catalyst-free section at a location at which said reactant stream enters said reaction section to promote oxidation reactions over reforming reactions, thereby to promote rapid heating of reactant gases in said reactant stream and the oxygen transport ceramic membranes.

10. The apparatus of claim 1, wherein said catalyst bed has an oxygen transport membrane-free section to define a catalytic equilibrating section.

11. The apparatus of claim 1, wherein each of the oxygen transport ceramic membranes is of tubular configuration and of composite construction and has a porous support layer located on the anode side and an adjacent dense membrane film located on the cathode side thereof.

12. The apparatus of claim 11, wherein a reforming catalyst of said catalyst bed is located in an outer portion of said porous support layer.

13. The apparatus of claim 1, wherein the reaction vessel has an outer jacket to preheat the oxygen containing stream and a passageway communicating between the outer jacket and the first heat exchanger for flow of the oxygen containing stream thereto after having been preheated.

14. A process for the production of synthesis gas including:
compressing an oxygen containing gas to a pressure in a range of about 1.5 bar and about 4 bar;
heating said oxygen containing stream to an interim temperature in a range of between about 300° C. and about 600° C.;
preheating a reactant stream comprising at least one hydrocarbon, steam and a recycle gas, selected from the group comprising: hydrogen, carbon monoxide, and carbon dioxide, to a temperature greater than 200° C.;
introducing said oxygen containing stream after having been heated into a first heat exchanger, located within a reaction vessel, to heat said oxygen containing stream by indirect heat exchange with an oxygen depleted stream;
introducing said reactant stream into a second heat exchanger, located within said reaction vessel, to heat said reactant stream to a temperature in a range of between about 500° C. and about 750° C. by indirect heat exchange with a synthesis gas product stream;
introducing said oxygen containing stream into a cathode side of a plurality of oxygen transport membranes located in a reaction section of the reaction vessel to separate oxygen from the oxygen containing stream, thereby to produce permeated oxygen at an anode side of the oxygen transport membranes;
introducing said reactant stream into a catalyst bed located at the anode side of said oxygen transport membranes and within the reaction section to promote the reaction of the permeated oxygen in a combination partial oxidation-reforming-water gas shift reaction to produce the synthesis gas product stream;
withdrawing the synthesis gas product stream from the reaction vessel after having been cooled through the indirect heat exchange with the reactant stream; and
withdrawing oxygen depleted gas from said reaction vessel after having been cooled through the indirect heat exchange with the oxygen containing stream.

15. The process of claim 14, wherein reactant gases of the reactant stream traverse the reaction section and therefore the catalyst bed in one of: axial flow, combined axial and transverse flow; spiral flow; radially-segmented cross-flow; and transverse-segmented cross-flow.

16. The process of claim 14, wherein at least one of the composition of the reactant gases, an oxygen permeate rate of the oxygen permeating through the oxygen transport membrane tubes, and the activity of catalyst activity of catalyst located within the reaction section to promote reaction of the reactant stream and the permeated oxygen, is adjusted to balance locally the heat of the endothermic reforming reactions with the heats of exothermic oxidation and water gas shift reactions to the extent required for maintaining said oxygen transport membrane tube within an operating temperature range between 800 and 1100° C.

17. The process of claim 14, wherein a buffer gas zone is located between the first heat exchanger and the reaction zone and a non-reactive gas is introduced into the buffer gas zone at a pressure higher than that of said reaction zone to prevent leakage of reactant gas from the reactant gas stream into an oxygen containing stream.

18. The process of claim 14, wherein the discharge temperature of the product synthesis gas stream from said product second heat exchanger is maintained above 700° C. to inhibit metal dusting therein and the product synthesis gas stream is further cooled outside of the reaction vessel in an external heat exchanger to below about 400° C. against boiling water to inhibit metal dusting in said external heat exchanger.

19. The process of claim 14, wherein liquid water is injected into the product synthesis gas stream after exiting said reaction section to partially cool said product synthesis gas stream by quenching, thereby to inhibit metal dusting in the said second heat exchanger.

20. The process of claim 14, wherein the oxygen containing gas stream and the reactant gas stream have a temperature difference of greater than about 200° C. where they enter reaction section.

21. The process of claim 14, wherein said reactant stream, within the second heat exchanger, is initially heated to a temperature of about 500° C., then flows through a catalytic pre-reforming section thereof in which hydrocarbons having more than one carbon molecule are reformed into hydrogen and carbon monoxide to inhibit the formation of free carbon at higher temperatures and, is then thereafter heated to a temperature of above about above 700° C.

22. The process of claim 14, wherein said reactant gas is subjected to a partial oxidation reaction with oxygen permeate prior to entering said catalyst bed.

23. The process of claim 14, wherein said reactant gas after said reaction section undergoes reforming reactions in the absence of oxygen permeate within an equilibrating section.

24. The process of claim 14, wherein said process is started by introducing a start-up air flow to the reactor and injecting fuel into the start-up air flow leaving the reaction section to react with oxygen in the start-up air stream and continually injecting said fuel until the oxygen transport membranes reach operating temperature, at which time the reactant stream is introduced into the second heat exchanger.
